(19) United States
(12) Patent Application Publication
(10) Pub. No.: US 2007/0011144 A1
(43) Pub. Date: Jan. 11, 2007

(54) Opportunity management, tracking, and reporting system

(75) Inventors: Lee M. Balan, New York, NY (US); Olivier Roux, New Rochelle, NY (US)

Correspondence Address: ACCENTURE CHICAGO 28164;BRINKS HOFER GILSON & LIONE, P O BOX 10395, CHICAGO, IL, 60610, US

(73) Assignee: Accenture Global Services GmbH

(21) Appl. No.: 11/177,626

(22) Filed: Jul. 8, 2005

(51) Int. Cl. G06F 17/30

(52) U.S. Cl. 707/3

(57) ABSTRACT

An opportunity management, tracking, and reporting system provides a consistent and accessible view of global business opportunities. The opportunity system manages multiple types of opportunities and tracks the opportunities as they evolve through their lifecycles. The opportunity system facilitates the full exploration and development of business opportunities, particularly those that emerge from proactive sales activities even as very preliminary opportunities. Consequently, the opportunity system helps to promote the successful development of opportunities into revenue streams.

### BACKGROUND

1. Technical Field

This invention relates to processing systems for managing, tracking, and reporting on business opportunities. In particular, this invention relates to a unified database architecture for managing, tracking, and reporting pro-active business opportunities as well as reactive business opportunities.

2. Background Information

The modern global marketplace is not an environment in which a service provider can wait for business to arrive on its own accord. Nevertheless, in the past some service providers focused a great deal on reactive opportunities stemming from potential client initiated contact with the service provider. In addition, service providers often focused on opportunities based on existing or prior services provided to a client.

Of course, service providers do proactively sell their services. When the service provider reaches a significant size, the service provider may employ hundreds of individuals assigned to any number of sales teams. The sales teams may be responsible for extensive geographical territories in the United States, Europe, Asia or anywhere else in the world, and may be responsible for working with any number of existing clients, new clients, and potential clients.

Regardless of how many individuals or teams were active, a common problem was present. In particular, although all working for the same service provider, the individuals and teams often operated independently. Accordingly, the individuals and teams employed disparate sales reporting, tracking, and management approaches. These approaches resulted in a multitude of sales data file formats, file organizations, and file content, stored on geographically dispersed computer systems and prepared by a wide range of applications of varying compatibility, such as Microsoft Word, Microsoft Excel (trademarks of Microsoft Corporation), Word Perfect (a trademark of Corel Corporation), Lotus Notes (a trademark of IBM Corporation), and other applications.

In this environment, upper level decision makers had the daunting task of reconciling the sales information. Before the decision makers could provide high level guidance or directives, they first had to find a way to understand the sales information originating with the many sales individuals and sales teams. To that end, the sales teams consumed extremely valuable and limited resources to convert, restate, or otherwise recast their sales data into forms that were at least recognizable by the decision makers.

Even after this expenditure of resources, the decision makers typically gained only a narrow view of sales performance, limited to each team. The wider view of reactive and proactive sales activities, over all the sales individuals and sales teams, remained a mystery. As a result, the sales efforts, particularly the proactive sales efforts, were not fully explored, promoted, and developed, leading to fewer sales and less revenue for the service organization.

Furthermore, as a client opportunity develops, the opportunity may evolve into a substantial profit opportunity with real potential, or the opportunity may become particularly important to the service organization in some other way. At this stage, ordinary members of a sales team should not be permitted to modify the opportunity records stored in a computer database. Instead, only primary decision makers should be able to update the opportunity records as the opportunity develops further. Nevertheless, it is not feasible to lock the members of the sales team out of the opportunity record since the sales team will require knowledge of the developing opportunity in order to perform their job. Accordingly, there is a technical problem to be solved of how to keep secure database records, data files, or other data sources relating to developed opportunities while nevertheless providing members of a sales team with the required level of access.

There is a need for addressing the problems noted above and others previously experienced.

### SUMMARY AND ADVANTAGES

An opportunity management, tracking, and reporting system (opportunity system) provides a unified portal into global business opportunities. The opportunity system may gather and process established opportunities as well as preliminary opportunities under one reporting paradigm. The opportunity system facilitates the full exploration and development of business opportunities through their entire lifecycles. Consequently, the opportunity system helps to ensure that opportunities, particularly emerging opportunities, do not languish undeveloped, and are properly tracked and accounted for as part of a global sales strategy.

According to one aspect of the invention an opportunity system is provided which includes an opportunity database, a memory, and a processor. The opportunity database includes opportunity records distinguished between pre-qualified opportunities, qualified opportunities, or other types of opportunities. In one embodiment, for example, one or more progress stage fields may denote the degree of development of an opportunity, and may establish a separation between pre-qualified opportunities and qualified opportunities. The opportunities may progress through any number of stages during their lifecycle.

The memory includes an import program which receives pre-qualified opportunities through a communication interface. The import program may then store the pre-qualified opportunities in the opportunity database. The import program obtains the pre-qualified opportunities from a pre-qualified opportunity repository, such as an independent secure database.

The memory also includes an opportunity search program. The search program facilitates viewing the opportunities according to multiple different search parameters, such as opportunity type, responsible operating group, responsible industry or offering, or any other search parameter. To that end, the search program accepts the opportunity search parameters, initiates an opportunity search in the opportunity database, and obtains the search results. The search program provides the search results to an opportunity reporting interface.

The processor populates the reporting interface with the search results. The reporting interface may vary widely depending on the desired implementation. In one embodiment, for example, the reporting interface may include a stage selection interface, a search result interface, and a supplemental opportunity search interface.

The stage selection interface provides the search results organized by their stage of development. The search result interface presents the detailed opportunity data retrieved from the opportunity database. The supplemental opportunity search interface provides a convenient search mechanism for additional searching.

According to another aspect of the invention, a database security system allows newly created data assets to develop without the need for access to a secure database which stores fully qualified assets. The security system includes a communication interface connected with the secure database. An asset development system in the security system provides an environment in which newly created data assets continue to develop and evolve.

The development system includes a working database which stores the newly created and developing data assets with an associated progress stage field. The development system also includes a memory which stores a data asset definition program and an export program. The data asset definition program accepts asset data which defines a developing data asset, establishes a developing data asset record based on the asset data, and updates over time the progress stage field in the working database. The export program analyzes the progress stage, determines when the developing data asset has advanced or evolved into a newly qualified data asset, and initiates communication of the newly qualified data asset through the communication interface for incorporation into the secure database. A processor executes the opportunity definition program and the export program.

Another aspect of the invention provides a method for searching a database which provides a technical solution to the data security problem previously identified. This aspect includes storing first category files in a first database and storing second category files in a second database. The second database may be a high security database with far more limited access than the first database. The method creates duplicate read-only copies of the second category files in the first database. Accordingly, the method may then perform a search of both the first category files and the duplicate copies of the second category files in the first database.

This aspect shields the second category files from alteration, while permitting full searches across both the second category files and the first category files. In one implementation, the first category files are pre-qualified opportunity data files and the second category files are qualified opportunity data files. Thus, this aspect maintains data records relating to developed or qualified opportunities on a separate, secure database (e.g., the second database) which permits full read/write access to only selected individuals. At the same time, this aspect provides limited access copies (e.g., read-only copies) of the qualified data records on a main database (e.g., the first database) which may then provide a complete picture of the entire set of pre-qualified and qualified opportunities.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 illustrates an opportunity management, tracking, and reporting system.

FIG. 2 shows an opportunity database which may be employed in the opportunity system shown in FIG. 1.

FIG. 3 shows an initial opportunity search user interface.

FIG. 4 illustrates an opportunity reporting user interface showing pipeline opportunities.

FIG. 5 illustrates an opportunity reporting user interface showing opportunity details.

FIG. 6 depicts an opportunity reporting user interface showing campaign progress stages.

FIG. 7 shows an opportunity definition user interface for establishing a new opportunity in the opportunity system.

FIG. 8 shows acts which may be taken by an import program running in the opportunity system shown in FIG. 1.

FIG. 9 shows acts which may be taken by an export program running in the opportunity system shown in FIG. 1.

FIG. 10 shows acts which may be taken by an opportunity search program running in the opportunity system shown in FIG. 1.

FIG. 11 shows acts which may be taken by an opportunity definition program running in the opportunity system shown in FIG. 1.

FIG. 12 shows an updating interface for providing a status update for opportunities assigned to campaign leads.

FIG. 13 shows a campaign status report interface.

FIG. 14 shows a sales status report interface.

### DETAILED DESCRIPTION

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are shown stored in program, data, or multipurpose system memories, all or part of systems and methods consistent with the technology may be stored on or read from other machine-readable media, for example, secondary storage devices such as hard disks, floppy disks, and CD-ROMs; electromagnetic signals; or other forms of machine readable media either currently known or later developed.

Furthermore, although this specification describes specific components of processing systems, in general, systems, methods, and articles of manufacture consistent with the technology may include additional or different components. For example, a processor may be implemented as a microprocessor, microcontroller, application specific integrated circuit (ASIC), discrete logic, or a combination of other types of circuits acting as explained above. Databases, tables, and other data structures may be separately stored and managed, incorporated into a single memory or database, split across multiple databases or memories, or generally logically and physically organized in many different ways. The programs discussed below may be parts of a single program, separate programs, or distributed across several memories and processors.

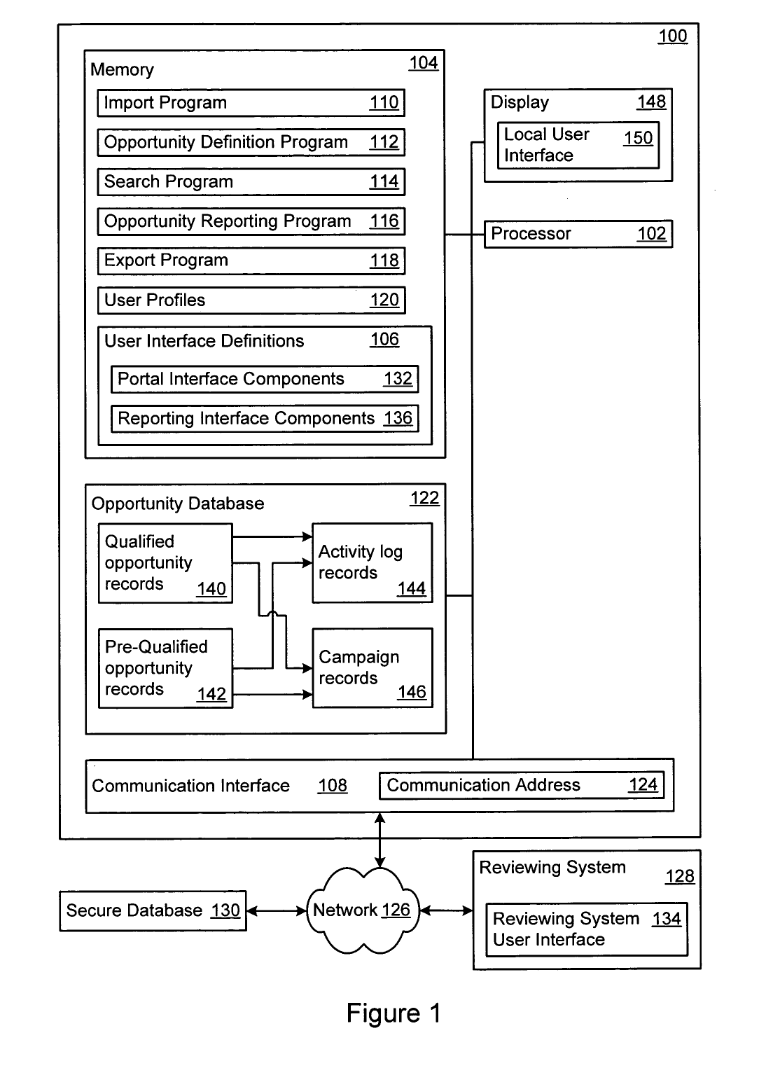

FIG. 1 shows an opportunity management, tracking, and reporting system (opportunity system) 100. The system 100 includes a processor 102, a memory 104, user interface definitions 106, and an opportunity database 122. In addition, a communication interface 108 is present.

The memory 104 holds an opportunity import program 110, an opportunity definition program 112, and an opportunity search program 114. The memory 104 also stores an opportunity reporting program 116, export program 118, and user profiles 120. The user profiles 120 include permission data which controls the type of access permitted to records in the opportunity database 122 based on a username or other identifier.

The communication interface 108 responds to an assigned communication address 124 to bi-directionally connect the system 100 to the internal or external networks 126. The communication interface 108 may include a network interface card or other communication circuitry which connects the system 100 to networks 126. In turn, the networks 126 connect to one or more reviewing systems 128, and/or secure databases 130.

Alternatively, the secure databases 130 may also be stored and managed inside the system 100. The secure databases 130 may operate as a repository for qualified opportunities. The secure databases 130 may strictly limit read, write, or modify access to the qualified opportunity data in the secure databases 130. For example, only a select set of individuals on a client team may have read and/or write access into the secure database 130. On the other hand, campaign team individuals have read and/or write access only to the opportunity database 122.

Depending on the implementation, a campaign team (which may not have access to the secure database 130) reviews pre-qualified opportunities. The campaign team may determine which pre-qualified opportunities have advanced to the point where a client team (which does have access to the secure database 130) should investigate adding the opportunity to the secure database 130. In other implementations, the export program 118 may automatically deliver newly qualified opportunities to the secure database 130, or to a client team with access to the secure database 130.

The networks 126 may adhere to any desired network topology or technology. For example, the networks 126 may be Ethernet networks and the communication address 124 may be a network address. The network address 124 may be a packet switched network identifier such as a Transmission Control Protocol/Internet Protocol (TCP/IP) address (optionally including port numbers), or any other communication protocol address. Generally, the networks 126 may represent a transport mechanism or interconnection of multiple transport mechanisms for data exchange between the system 100 and the remote systems 128 and secure databases 130.

The reviewing systems 128 may represent local or remote entities (e.g., desktop or portable computers, personal data assistants, cell phones, or other entities) which connect to the system 100. To that end, the user interface definitions 106 include portal interface components 132. The system uses the interface components 132 to display, at the reviewing system 128, a portal login screen as part of a reviewing system user interface 134.

Similarly, the user interface definitions 106 also include opportunity reporting interface components 136. The reporting interface components 136 may define one or more opportunity reporting user interface screens for display at the remote system 128 on the reviewing system user interface 134. The portal interface components 132 and/or reporting interface components 136 may include HTML or other markup language instructions, active server page components, Java™ applets, text, visual elements, interactive components (e.g., drop down lists), or any other component of a portal user interface display. Alternatively or additionally, the system 100 may include a local display 148 which displays a local user interface 150 for presenting the portal login screen and reporting interface screens to a local user. The reporting interface screens and their components are explained in more detail below.

The reviewing systems 128 provide local or remote access by sales individuals, sales teams, administrators, management executives, or other individuals to a consistent tracking and reporting interface for the opportunities in the opportunity database 122. For example, when the system 100 tracks sales opportunities, the opportunity database 122 may provide a globally consistent view of not only fully qualified or established opportunities, but also pre-qualified opportunities, and any other opportunity at any stage of its progress. The opportunity database 122 may also store and report activity and campaign information for the opportunities.

Accordingly, the opportunity database 122 defines tables which hold records for opportunity information, opportunity activities, and campaign activities. In the example shown in FIG. 1, the opportunity database 122 defines tables which store qualified opportunity records 140 and pre-qualified opportunity records 142. The qualified opportunity records 140 may include opportunity data for qualified opportunities imported from the secure database 130. The pre-qualified opportunity records store opportunity data for target opportunities defined in the system 100.

The opportunity database 122 also defines a table which stores activity log records 144. The activity log records 144 capture specific developments in an opportunity and are linked to a qualified opportunity record 140 or a pre-qualified opportunity record 142 using opportunity identifiers as a primary key. Similarly, the opportunity database 122 defines a table which stores opportunity campaign records 146. The opportunity campaign records 146 include entries for the opportunity progress stage, campaign lead, and other campaign data. The campaign records 146 are also linked through a primary key to qualified opportunity records 140 or a pre-qualified opportunity record 142.

An opportunity may advance through any number of progress stages. To qualify for each stage, an opportunity may need to meet one or more pre-defined criteria. Furthermore, at any progress stage, an opportunity may be considered to fall in a general category of opportunity. The progress stages thereby divide opportunities between the categories, and each category may span one or more progress stages.

In the examples discussed below, an opportunity moves through seven progress steps or stages. Newly defined ‘Target’ opportunities may start at progress stage 0. To qualify for stage 1, the opportunity may, for example, need to be confirmed or validated with an internal authority such as an account executive. To move to stage 2, the opportunity may, for example, need to have in place an execution strategy, such as a ‘win strategy’ for successfully selling the opportunity to the client. Stage 3 may require the opportunity to have been presented at a client meeting.

Once an opportunity has reached stage 3, the opportunity is generally well defined and continues to look viable. To move to stage 4, the individual responsible for the opportunity may, for example, need to return to the potential client to validate the client interest in the opportunity. Advancing to stage 5 may require the responsible individual to refine the scope of the opportunity to more specifically define the opportunity in response to the client requirements. Finally, at stage 6, the opportunity may need to have been sold to the client or withdrawn (whether permanently or temporarily).

An opportunity at any of stages 0-3 may be considered to be in the category of a ‘Pre-qualified Opportunity’ or ‘Target Opportunity’. At any of stages 4-6, the opportunity may be considered to be in the category of a ‘Qualified Opportunity’, and may be entered into the secure database 130 as explained in more detail below. Subsequently, the opportunity record in the opportunity database 122 may be updated with the secure database ID assigned to the opportunity.

The progress stages may further subdivide any opportunity category. For example, a stage 4 qualified opportunity may be considered to be in the ‘Under Construction’ sub-category in the secure database 130. At stage 5, the qualified category opportunity may be considered to be in a ‘Prospective’ opportunity sub-category. Finally, at stage 6, the qualified category opportunity may fall into a ‘Pipeline’ opportunity category. Any other stages, categories, sub-categories, or qualifications for each stage, category, or sub-category may be defined and implemented, however.

More generally, the database 122 may store data assets of any type in the database records. The data assets may represent mechanical designs for parts or systems of parts, data structures under design, schematics, VLSI layouts, or other circuitry designs, blueprints or other plans for buildings, roads, or other structures, or any other type of data asset. The system 100 then permits the data assets to evolve over time from, for example, a newly established and developing data asset to a fully evolved and approved data asset.

The data assets evolve in the system 100 without the need to access, modify, or view the data assets in the more secure database 130. However, when the developing data assets have reached maturity (e.g., are in final form, at a final development stage, or have been completed and approved), the system 100 may initiate transfer of the matured data assets to the secure database 130 as described below.

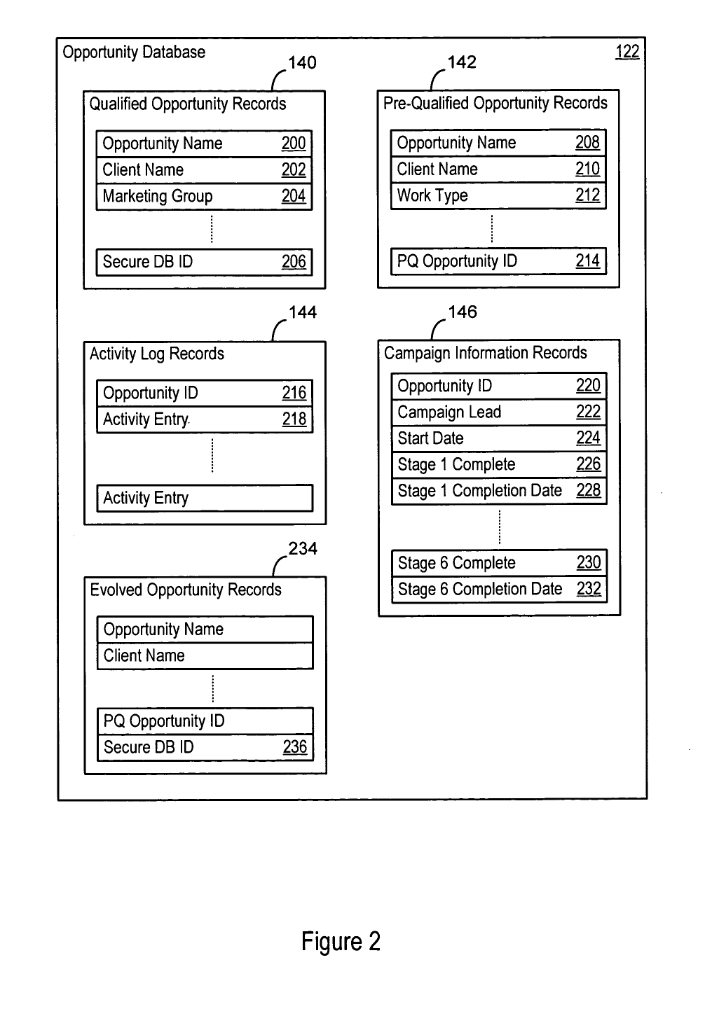

FIG. 2 shows one implementation of the opportunity database 122 and the records 140-146. The qualified opportunity records 140 include fields which characterize qualified opportunities imported from the secure database 130. As examples, the qualified opportunity records 140 may include an opportunity name field 200, a client name field 202, a marketing group field 204, and/or any other fields which provide information about qualified opportunities.

The qualified opportunity records 140 may be made read-only. Their presence in the database 122 allows them to be searched and allows the system 100 to provide a complete picture of all opportunities being pursued. At the same time, their read-only nature prevents the qualified opportunity records 140 from being modified in the system 100. The secure database 130 thereby maintains write/delete/modify access control over the qualified opportunities.

In addition, the qualified opportunity records 140 may include a secured database ID field 206. The ID field 206 may include a unique identifier for the qualified opportunity represented by the opportunity record. The secure database 130 may generate the unique identifier, and the system 100 may import the identifier for use in the qualified opportunity records 140. For example, the system 100 may use the ID field 206 as a primary key linking activity log records 144 and campaign information records 146 to a qualified opportunity record.

Similarly, the pre-qualified opportunity records 142 include fields which characterize pre-qualified opportunities. As examples, the opportunity records 142 include an opportunity name field 208, a client name field 210, and a work type (e.g., ‘consulting’, or ‘outsourcing’) field 212. Additionally, the pre-qualified opportunity records 142 may also include a pre-qualified opportunity ID field 214.

The ID field 214 may include a unique identifier for the pre-qualified opportunity represented by the pre-qualified opportunity record. The system 100 may generate the unique identifier and store the unique identifier in the pre-qualified opportunity record at the time the pre-qualified opportunity record is established. The system 100 may use the pre-qualified opportunity ID field 214 as a primary key linking activity log records 144 and campaign information records 146 to a pre-qualified opportunity record.

Activity log records 144 are also present in the opportunity database 122. In one implementation, the activity log records include an opportunity ID 216 and an activity entry 218. The activity log records 144 may store any data which captures activity on an opportunity. The opportunity ID 216 links each activity log record 144 back to a pre-qualified opportunity record 142 or qualified opportunity record 140. The activity entry 218 may be a text, image, or other data field which captures information relating to the activity. For example, a text activity entry may provide a written description of any activity, such as a description of a client meeting, discussion, planning session, conference call, or any other type of activity.

The campaign information records 146 store data related to the process of taking or selling the opportunity to a client (i.e., the opportunity campaign). To that end, the campaign information records 146 may include an opportunity ID field 220, a campaign lead field 222, and a start date field 224. The opportunity ID field links the record back to a pre-qualified or qualified opportunity record. The campaign lead field 222 may store the name of an individual responsible for the opportunity campaign, while the start date field 224 may store a date on which the campaign began.

The campaign information records 146 may also store data which establishes how far an opportunity has evolved or progressed. In the example shown in FIG. 2, each opportunity may exist at one of seven different stages. For example, newly created target opportunities may start at a progress stage of 0. Fully qualified pipeline opportunities may exist at a progress stage of 6. Accordingly, the campaign information records 146 include a stage completion field, a stage completion date field, or any other implementation of a progress stage field. FIG. 2 shows two examples: a stage 1 complete field 226 associated with a stage 1 completion date field 228, and a stage 6 complete field 230 associated with a stage 6 completion date field 232. The campaign information records 146 may define more, fewer, or different progress stage fields.

When an opportunity completes a particular stage, the system 100 may set the completion fields 226 and 230 to indicate that the stage has been completed. The completion fields 226 and 230 thereby act as Boolean indicators of whether the opportunity has reached any given stage. In addition, the system 100 sets the completion date fields 228 and 232 to the date on which the opportunity completed the associated stage. The system 100 thereby tracks the evolution of an opportunity through its life.

FIG. 2 also shows evolved opportunity records 234. When a pre-qualified opportunity advances to become a qualified opportunity, the system 100 may create an evolved opportunity record to track the successful development of that pre-qualified opportunity. The evolved opportunity records 234 may store all or only a portion of the data maintained in the pre-qualified opportunity records 142. The evolved opportunity records 234 may further include an identifier field 236 which stores the secured database identifier assigned to the opportunity by the secured database 130.

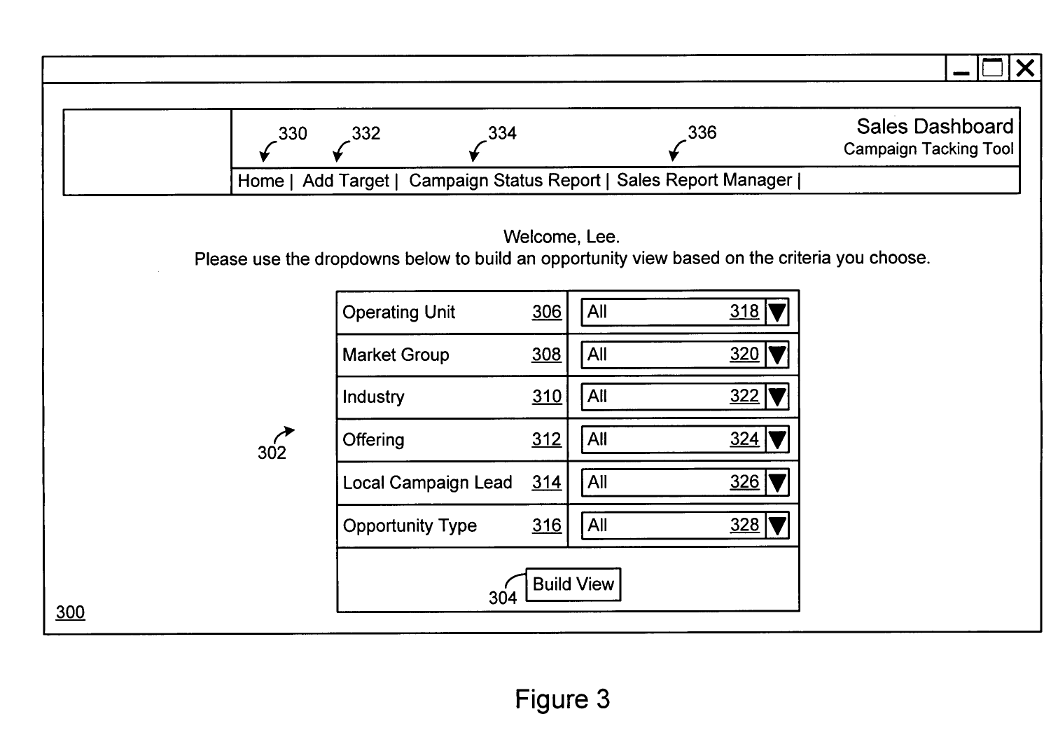

FIG. 3 shows an initial opportunity search interface 300. The search interface 300 includes a search parameter interface 302 and a search initiation selector 304. The search parameter interface 302 includes identifiers for search parameters and parameter selectors.

In the example shown in FIG. 3, the opportunity search interface 300 includes the Operating Unit search parameter identifier 306, the Market Group search parameter identifier 308, and the Industry search parameter identifier 310. The search interface 300 also includes the Offering search parameter identifier 312, the Local Campaign Lead search parameter identifier 314, and the Opportunity Type search parameter identifier 316. Each identifier 306-316 is paired with a parameter selector. In FIG. 3, the parameter selectors are drop down lists 318, 320, 322, 324, 326, and 328. The system 100 may provide more, fewer, and/or different search parameters and/or parameter selectors.

The Operating Unit search parameter and associated drop down list 318 may provide a selection between geographically assigned business operating units. Examples of such areas are ‘North America’, ‘Europe’, and ‘Asia’. Any other geographic areas may be used.

The Market Group search parameter and associated drop down list 320 may provide a selection among geographic marketing areas within the Operating Unit. Examples of such areas are ‘West’, ‘North’, and ‘Mid-Atlantic’. Any other geographic areas may be used.

The Industry search parameter and associated drop down list 322 may provide a selection among types of business. Examples of types of business are ‘Banking’, ‘Capital Markets’, and ‘Insurance’. Any other business types may be used.

The Offering search parameter and associated drop down list 324 may provide a selection among marketable products or services. Examples of types of offerings are ‘HR Transformation Services’, ‘Business Process Outsourcing’, and ‘Regulatory Management’. Any other offerings may be used.

The Campaign Lead parameter and associated drop down list 326 may provide a selection among individuals who are responsible for driving, managing, or overseeing sales campaigns. The system 100 may populate the campaign lead drop down list 326 on a per offering and/or per operating unit basis, or based on any other of the search parameters.

The Opportunity Type parameter and associated drop down list 328 may provide a selection among pre-defined types of opportunities. As one example, the opportunity types may include ‘Active’ opportunities, e.g., opportunities which are still being promoted to a client. As another example, the opportunity types may include ‘Inactive’ opportunities, which apply to opportunities which are no longer being offered or promoted. The opportunity types may further include ‘Won’ (e.g., sold to the client), ‘Lost’ (e.g., refused by the client), or ‘Withdrawn’ (e.g., temporarily inactive) opportunities.

The system 100 generates the search interface 300 (e.g., using HTML and active server pages) on the reviewing system user interface 134 and/or local user interface 150. The system 100 generates the search interface 300 after an individual has provided a valid login ID and password to the system 100. The system 100 accesses the user profiles 120 to determine, based on the login ID, the access level available to the individual. The access level may permit the individual to view all, none, or any subset of the opportunities in the opportunity database 122.

The access level determines which opportunities are available for review by the individual. Based on the access level, the system 100 populates the opportunity search parameter interface 302 with search criteria which provide the appropriate level of access. For example, the user profile may constrain an individual to be able to search only for opportunities in the North America operating group. Continuing the example, the user profile may further restrict the marketing group choices to ‘West’ and ‘South’ within the ‘North America’ operating group.

After the individual has selected the search parameters of interest, the individual may activate the search initiation selector 304. In response, the system 100 initiates a search for opportunities in the opportunity database 122 that meet the selected search parameters. The system 100 responds by building a view of the search results in an opportunity reporting interface displayed on the reviewing system user interface 134 and/or local user interface 150.

The search interface 300 may also provide links to other functionality in the system 100. FIG. 3 shows that the search interface 300 includes a ‘Home’ link 330, an ‘Add Target’ link 332, a ‘Campaign Status Report’ link 334, and a ‘Sales Report Manager’ link 336 which are explained in more detail below. More, fewer, or different links may be provided.

The ‘Home’ link 300 may redirect the individual to a home page for the system 100. The home page may be a login page which accepts a username and password. The ‘Add Target’ link 332 may direct the individual to a screen or series of screens through which the individual may define a new opportunity which the system 100 will track. The ‘Campaign Status Report’ link 334 may redirect the individual to campaign status reporting screens which the system 100 may employ to provide consistent reporting on the progress of any or all of the opportunities in the opportunity database 122. The Sales Report Manager’ link 336 may redirect the individual to a reporting screen or screens which the system 100 may employ to consistently report sales data arising from selected opportunities in the opportunity database 122.

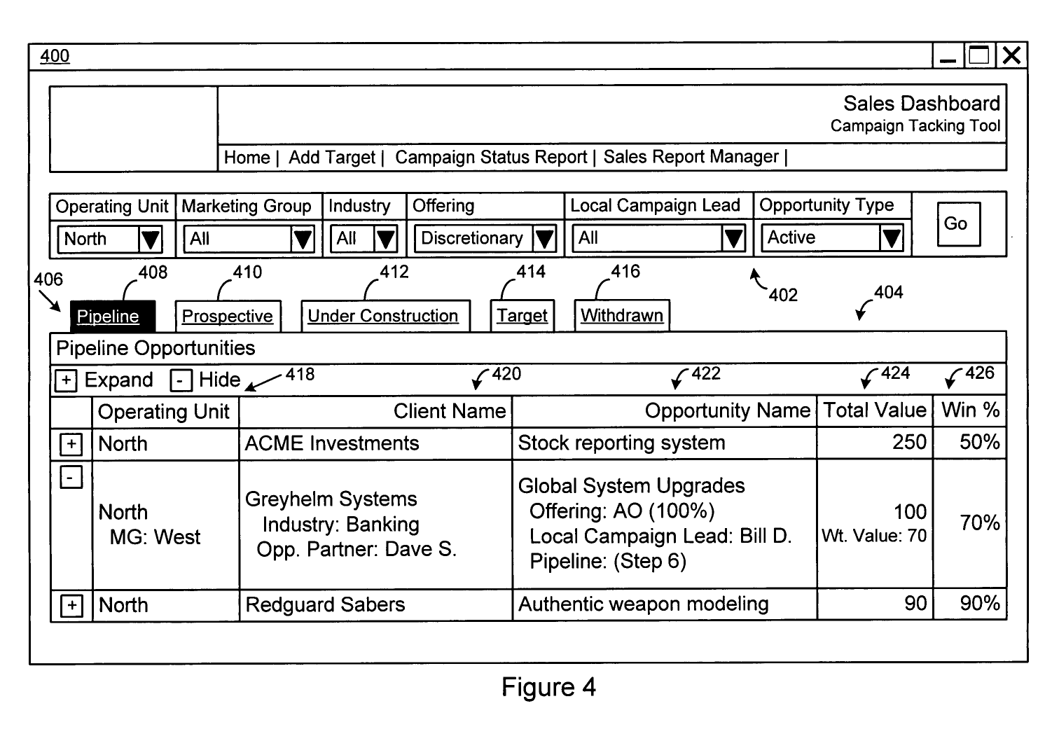

FIG. 4 shows an opportunity reporting user interface 400. The system 100 populates the interface 400 with the search results from the opportunity search. The opportunity reporting user interface 400 includes a supplemental opportunity search interface 402, a search result reporting interface 404, and a stage selection interface including review selection tabs 406: the ‘Pipeline’ selector tab 408, the ‘Prospective’ selector tab 410, the ‘Under Construction’ selector tab 412, the ‘Target’ selector tab 414, and the ‘Withdrawn’ selector tab 416. The system 100 responds to each of the selector tabs 408-416 by displaying data from the search result corresponding to the chosen selector.

In the example shown in FIG. 4, the reporting interface 404 shows data from a search for ‘Discretionary’ offerings of ‘Active’ opportunities in the ‘North’ operating unit. The Pipeline tab 408 is chosen, and the system 100 displays search result data for pipeline opportunities returned in the search. Under the Pipeline tab, the reporting interface 404 may include an operating unit entry 418, a client name entry 420, and an opportunity name entry 422 for each search result.

In addition, the reporting interface 404 may report metrics using, for example, the total value metric entry 424 and the win percentage metric entry 426. The total value may represent the dollar value of the opportunity (e.g., the value of a complete outsourcing engagement). The win percentage may represent the degree of progress may toward winning the opportunity (e.g., the progress toward signing a contract with the client for the outsourcing engagement). Additional, fewer, or different entries and metrics may be employed, calculated, and displayed.

The reporting interface 404 may present the pipeline search results in a summary manner or in a more detailed manner. The expand buttons and the hide buttons may be used to switch between the two views. In the example shown in FIG. 4, the ‘ACME investments’ search result is shown in a summary manner, while the ‘Greyhelm Systems’ search result is displayed in a more detailed manner. The additional detail may include any information beyond what is shown in the summary form. As shown in FIG. 4, the detailed display includes marketing group information, industry, and opportunity partner information. In addition, the detailed display includes offering, local campaign lead, and progress stage (‘Step 6: Pipeline’) information. The weighted value (i.e., the total value multiplied by the win percentage) is also present in the detailed view.

The reporting interface 400 responds to the activation of the selector tabs 408-416 to display similar information for other opportunities in the search results. With regard to the ‘Prospective’ selector tab 410, the reporting interface 400 may display any available information in the search results for Prospective opportunities. As noted above, the Prospective opportunities may be less far along in their development stage than the Pipeline opportunities, and may not have a total value, start, or end dates. In the example explained above with regard to FIG. 2, the prospective opportunities may be associated with a progress stage at step 5.

Similarly, the reporting interface 400 responds to the activation of the ‘Under Construction’ selector tab 412 to display any available information in the search results for opportunities in the ‘under construction’ sub-category. As noted above, the ‘under construction’ opportunities may be qualified opportunities at progress stage 4.

The activation of the ‘Target’ selector tab 414 causes the reporting interface 400 to display any information available in the search results for pre-qualified opportunities. As noted above, pre-qualified opportunities may be opportunities for which a client has not yet shown interest. Instead, the pre-qualified opportunities may represent pro-active sales efforts tracked and reported by the system 100. Pre-qualified opportunities are not stored in the secure database 130, but are maintained locally in the system 100. In the example given above with respect to FIG. 2, the pre-qualified opportunities may be associated with progress stages of 0, 1, 2, or 3.

The reporting interface 400 responds to the ‘Withdrawn’ selector tab 416 by displaying opportunities that were targets at one time, but that were terminated. The withdrawn opportunities may have started as pre-qualified opportunities, but did not develop far enough to reach ‘under construction’, ‘prospective’, or ‘pipeline’ stage. Regardless, the system 100 may maintain the record of each withdrawn opportunity, and may report and track such opportunities. Furthermore, withdrawn opportunities may emerge from their withdrawn status to become active opportunities in the future.

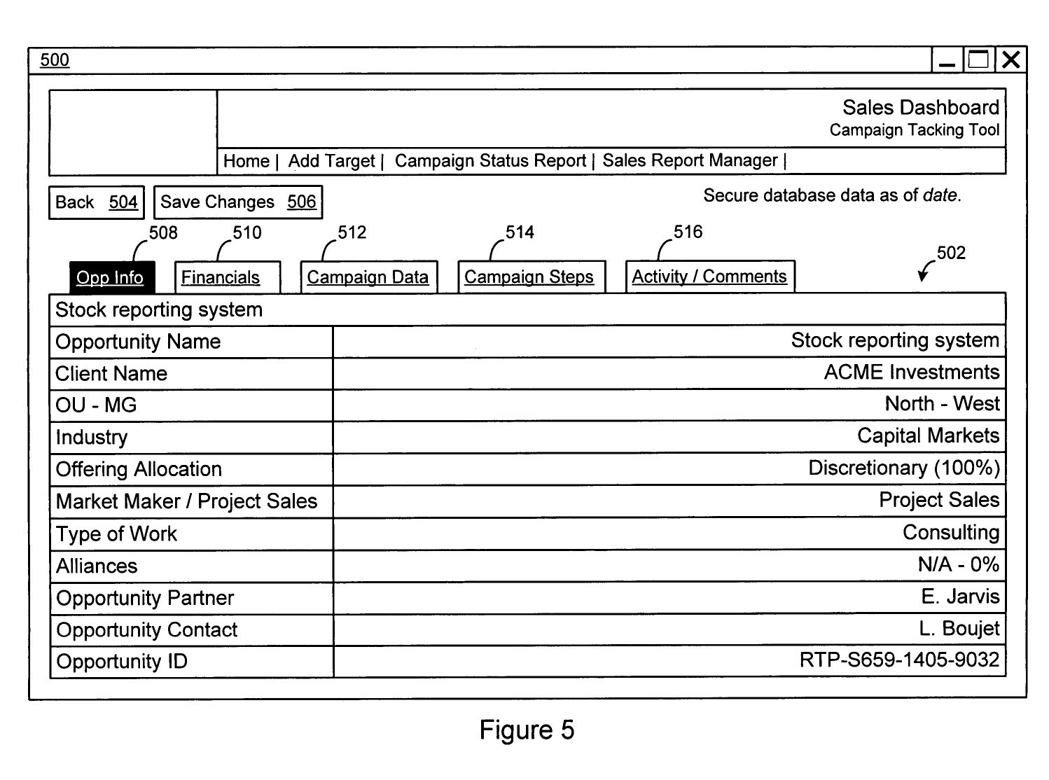

The reporting interface 400 allows the user to drill down into each opportunity to view additional opportunity detail. FIG. 5 shows one example of an opportunity reporting interface 500 for reporting opportunity information detail. The system 100 displays the reporting interface 500 when the user clicks on an opportunity in the reporting interface 400. In the example shown in FIG. 5, the reporting interface 500 shows detailed information for the ‘ACME investments’ stock reporting system pipeline opportunity.

The interface 500 includes a detail reporting interface 502 which presents the detailed opportunity information, a ‘Back’ navigation button 504, and a ‘Save Changes’ button 506. The system 100 responds to the ‘Back’ navigation button 504 to return the user to the opportunity reporting user interface 400. The ‘Save Changes’ button 506 initiates an opportunity database 122 update based on the additions, deletions, or updates to information in the opportunity detail interface 500.

In addition, the interface 500 includes detail selection tabs: the ‘Opportunity Information’ tab 508, the ‘Financials’ tab 510, the ‘Campaign Data’ tab 512, the ‘Campaign Steps’ tab 514, and the ‘Activity/Comments’ tab 516. The system 100 responds to each tab 508-516 by presenting detailed opportunity information consistent with the selected tab. In one implementation, the reporting interface 500 responds to selection of the ‘Opportunity Information’ tab 508 by presenting core opportunity details, such as the opportunity name, client name, operating unit, marking group, industry, responsible partner, contact, opportunity identifier, and other core details. The opportunity information tab 508 may also display ‘Service Stack’ information which conveys the manner in which an opportunity will be delivered to a client. As examples, the ‘Service Stack’ information may associate opportunity delivery with Application Outsourcing, Business Processing Outsourcing, IT Transformation services, or other delivery mechanisms. The ‘Service Stack’ information may further convey the nature of the delivery, such as taking cost out of a client organization, or adding value into the client organization.

The reporting interface 500 responds to selection of the ‘Financials’ tab 510 by displaying detailed financial data for the opportunity. For example, the reporting interface 500 may display opportunity total value or revenue (e.g., consulting and outsourcing net revenue), win percentages for the opportunity, weighted value, and start and end dates for the opportunity.

Under ‘Campaign Data’, the reporting interface 500 displays detailed information concerning the overall direction of the opportunity. As examples, the reporting interface 500 may report the campaign lead (i.e., the individual who is primarily responsible for the global direction and management of the opportunity), the opportunity owner (i.e., the individual who is primarily responsible for actively developing the opportunity), and the start date (i.e., the date on which the opportunity began). Additionally, the reporting interface 500 may display the dialogue level (i.e., an identifier of which client individual has been contacted or has discussed the opportunity, such as the CFO, COO, CEO, VP, or other individual), the name of the client individual, and the priority for the opportunity.

The ‘Activity/Comments’ tab 516 provides access to a data entry field (e.g., a text, image attachment, sound file attachment, or other data entry field) in which the user may enter comments about the opportunity. The system 100 saves each comment in the database 122. The system 100 thereby maintains the comments as a historical record of activity for the opportunity.

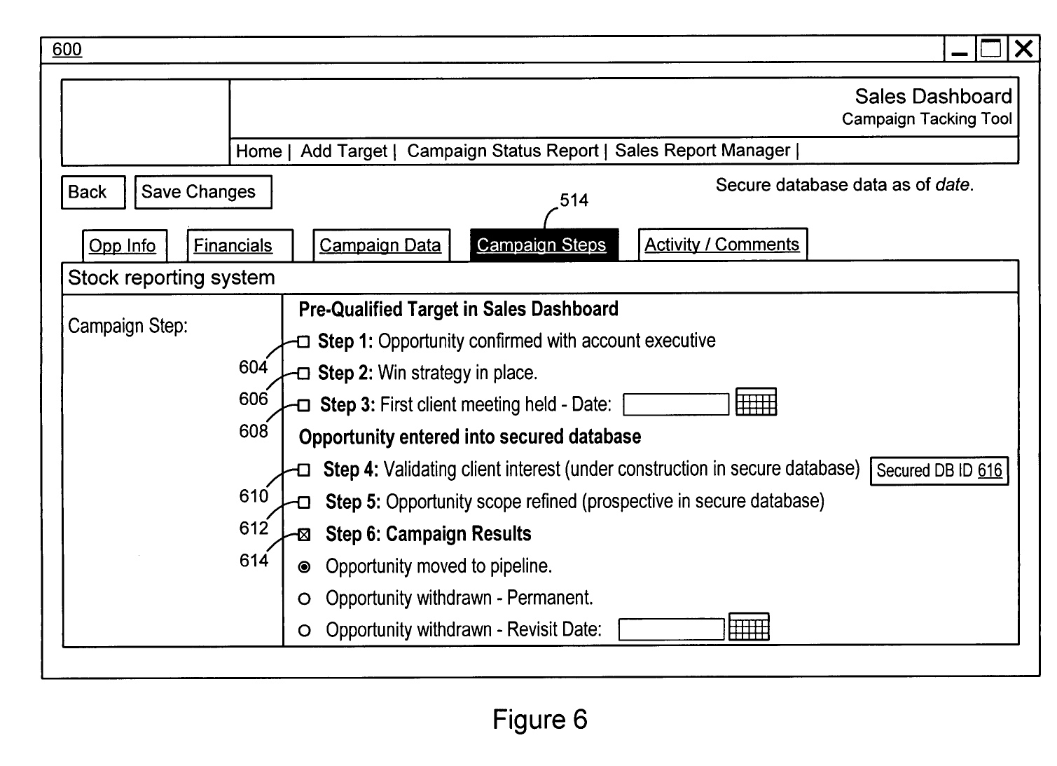

The ‘Campaign Steps’ tab 514 causes the system 100 to display the progress stage interface 600 shown in FIG. 6. In the example shown in FIG. 6, six steps are defined, although more, fewer, or different steps may be employed. The progress stage interface 600 presents a set of progress stage selectors 604, 606, 608, 610, 612, and 614 for the opportunity. The user may click on the appropriate selector to set the correct progress stage for the opportunity. Thus, the system 100 tracks the evolution of the opportunity as it evolves from a pre-qualified opportunity to a fully qualified opportunity. The system 100 updates the progress stage completion and completion date fields in the campaign records 146 according to the progress stage selection.

As noted above, opportunities which evolve to a pre-selected progress stage (e.g., stage 4) may be considered qualified opportunities. At that point, a client team (or other entity with full access to the secure database 130) may enter the newly qualified opportunity into the secure database 130. In one implementation, a campaign team (which may not have access to the secure database 130) may review opportunities to determine which opportunities have sufficient progress to warrant a recommendation to a client team to add the opportunity to the secure database 130. In other implementations, the export program 118 may automatically deliver newly qualified opportunity data (e.g., including the opportunity information, financial information, and campaign data information) to the secure database 130, or to a client team with access to the secure database 130.

The secure database 130 creates a unique identifier for each qualified opportunity in the secure database 130. After establishing the qualified opportunity in the secure database 130, the secure database 130 may communicate the unique identifier to the system 100. In one implementation, the client team communicates the unique identifier to the campaign team. The campaign team may then add the unique secure database identifier in the ID field 616 provided in the interface 600. Alternatively, the system 100 may automate adding the unique ID.

The system 100 tracks the pre-qualified opportunities that evolve into qualified opportunities. In one implementation, the system 100 may migrate the data for a newly qualified opportunity into a new evolved opportunity record 234. For example, the system 100 may copy the data in the pre-qualified opportunity record 142 for that opportunity into the new evolved opportunity record. The system 100 may also add the secure database identifier assigned to the now qualified opportunity.

The system 100 also provides functionality for defining new target opportunities. For example, in response to activation of the ‘Add Target’ link 332, the system 100 may display one or more opportunity definition interfaces. The interfaces provide data input fields which allow the campaign team to select or enter opportunity information, financial information, campaign data, campaign steps, and comments as described above in connection with FIG. 5. The opportunity definition interfaces may accept any other data, however.

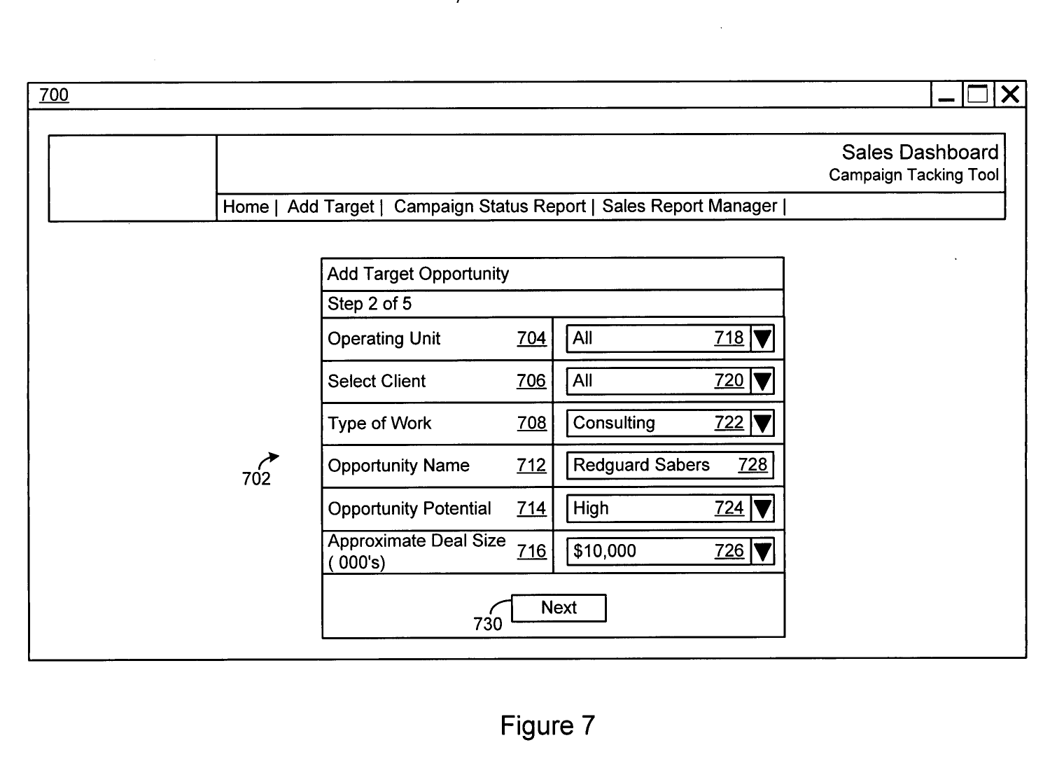

The system 100 may spread the entry of new target data over one or more interfaces and/or interface screens. FIG. 7 shows one example of an opportunity definition interface 700. The interface 700 includes an input interface 702 which includes characteristic identifiers and characteristic inputs. The characteristic identifiers provide an indication of the target opportunity characteristic being set.

In the example shown in FIG. 7, the characteristic identifiers are an ‘Operating Unit’ identifier 704, a ‘Select Client’ identifier 706, and a ‘Type of Work’ identifier 708. The identifiers further include an ‘Opportunity Name’ identifier 712, an ‘Opportunity Potential’ identifier 714, and an ‘Approximate Deal Size’ identifier 716. The characteristic inputs include the drop down lists 718, 720, 722, 724, and 726, and the text input field 728. The system 100 may populate the drop down lists or any other characteristic input with selections suitable for any given operating unit, client name, or other characteristic. The ‘Next’ button 730 may advance the opportunity definition interface to the next screen.

In one implementation, the interface 700 is the second in a set of five opportunity definition interface screens. The system 100 may first display an interface screen which accepts a selection of an operating unit and a client name. These selections may drive the selections available in subsequent data selection fields, (e.g., drop down lists), such as those shown in FIG. 7.

The third definition interface screen may include data entry fields for financial information. The financial information may include estimated opportunity value, win probability (e.g., high, medium, or low), start date, end date, or any other financial information. The fourth definition interface screen may include data entry fields for target opportunity campaign information. The campaign information may include the local campaign lead, the opportunity owner, the scheduled campaign start date, a highest level of executive dialog at the potential client, and any other information related to the campaign for the target opportunity. The fifth definition interface screen may include data entry fields which allow the campaign team to set the current campaign progress stage, as discussed above in connection with FIG. 6.

Once the system 100 has captured the data characterizing a new target opportunity, the system 100 creates a record for the target opportunity in the opportunity database 122. The system 100 tracks the development of the target opportunity through its lifetime. In addition, the system 100 provides consistent reporting of the target opportunities and qualified opportunities, as described in more detail further below.

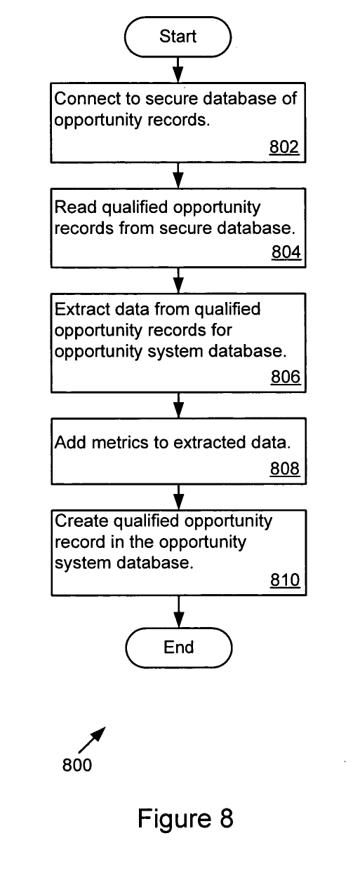

FIG. 8 shows the acts 800 that the import program 110 may take. The import program 110 may execute on a regular schedule (e.g., each hour, nightly, or weekly), when instructed by an operator of the system 100, or in response to defined events. The import program 110 connects to the secure database 130 through the communication interface 108 (Act 802). Once connected, the import program 110 reads qualified opportunity records from the secure database 130 (Act 804). The import program extracts any desired data from the qualified opportunity records (Act 806), including opportunity information, financial information, campaign information, activity or comments, or any other desired data.

For tracking and reporting purposes in the system 100, the import program 110 may also add metrics to the extracted data (Act 808). For example, the import program 110 may add sales metrics, opportunity value metrics, or other metrics, optionally based on sales reports present in the qualified opportunity records. The import program 110 and system 100 then create a qualified opportunity record in the opportunity database 122 representing the imported opportunity (Act 810). The import program 110 may import any number of qualified opportunities from the secured database 130.

In addition to importing qualified opportunities, the system 100 also provides a source of newly qualified opportunities to the secure database 130. In some implementations, the check for newly qualified opportunities may be performed manually by campaign teams and/or client teams. Furthermore, the decision to create a new qualified opportunity record in the secure database 130 also may be determined manually. In other implementations, the export program 118 may send newly qualified opportunity data directly to the secure database 130 or to a client team. The client team may decide whether to create a new qualified opportunity record in the secure database 130.

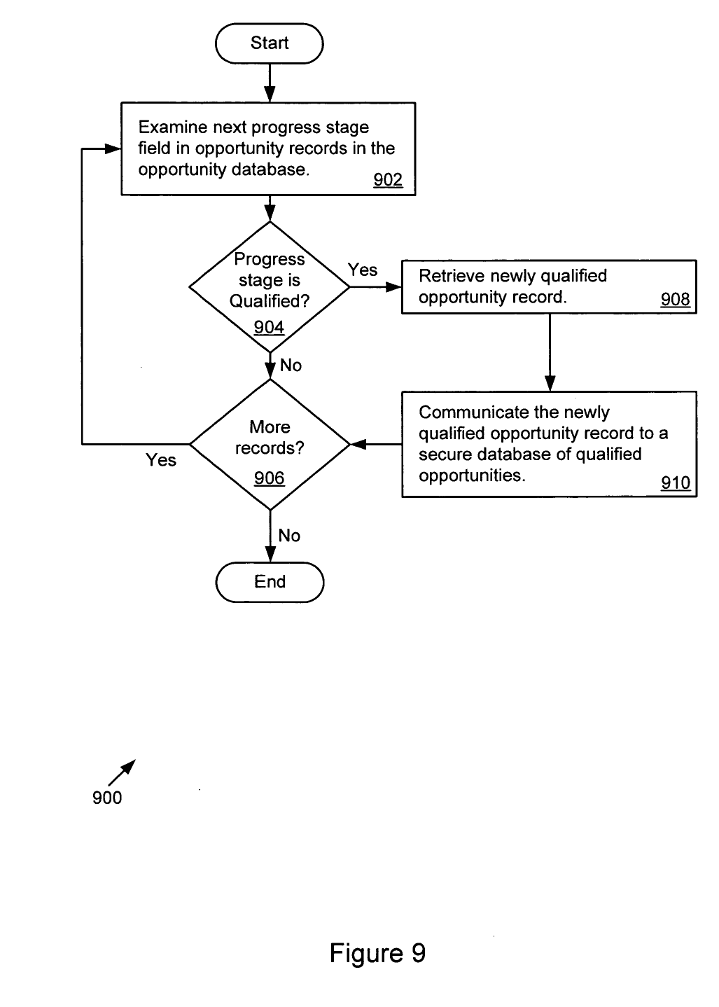

FIG. 9 shows one example of the acts 900 that the export program 118 may take. The export program 118 examines the campaign information records 146 to ascertain the progress stage of each pre-qualified opportunity (Act 902). The check may be performed on a periodic or non-periodic basis, as requested, or according to any other initiator. The stage completion fields in the campaign information records 146 indicate the progress stage for each opportunity. If a pre-qualified opportunity has not evolved into a qualified opportunity (Act 904), the export program examines the next record until each record has been checked (Act 906).

The stage completion fields may indicate that a pre-qualified opportunity has evolved to a newly qualified opportunity. For example, the stage completion fields may indicate that an opportunity has reach stage 4. For such newly qualified opportunities, the export program 118 may retrieve the opportunity, campaign, and activity records for that opportunity (Act 908). The export program 118 may then communicate the retrieved data to the secure database 130 (Act 910), to a client team via email, a file transfer protocol, or any other communication method.

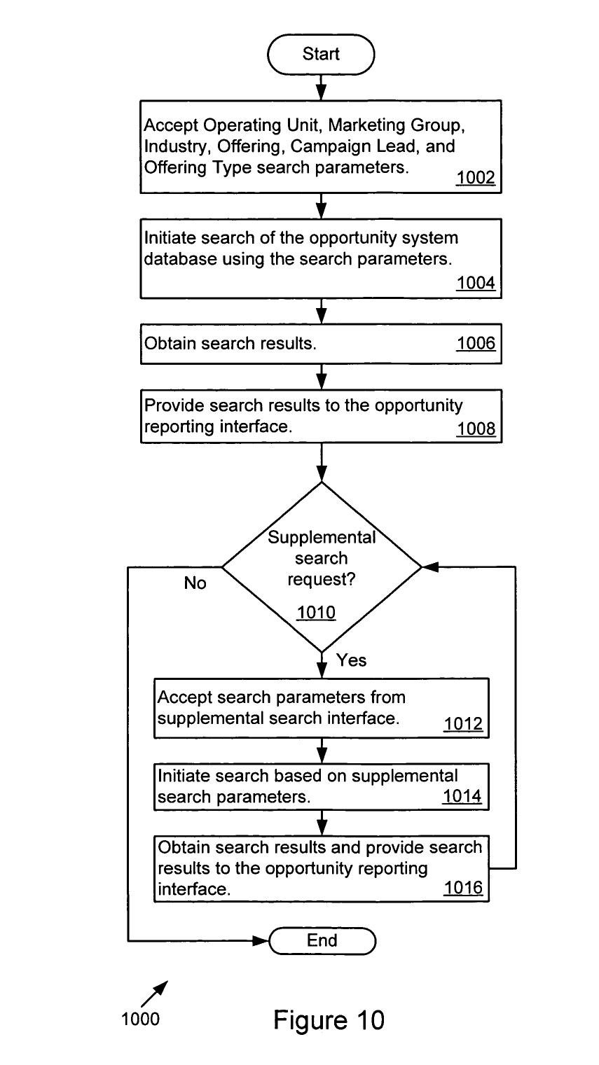

FIG. 10 shows the acts 1000 which the opportunity search program 114 may take. The search program 114 accepts search parameters, such as an operating unit, marketing group, offering type, or other search parameters (Act 1002). The search program 114 then initiates a search of the opportunity database 122 (Act 1004) and obtains the search results (Act 1006).

Once the search results are available, the search program 114 provides the search results to the opportunity reporting interface 400 (Act 1008). The system 100 populates the reporting interface 400 with the search results. As noted above, the interface 400 includes a supplemental search interface 402. Accordingly, the search program 114 may determine whether a supplemental search request has been issued (Act 1010).

For a supplemental search, the search program 114 accepts the supplemental search parameters (Act 1012). The search program 114 then initiates a search based on the supplemental parameters (Act 1014). Once the search program 114 obtains the search results, the search program 114 provides the search results to the opportunity reporting interface 400 (Act 1016).

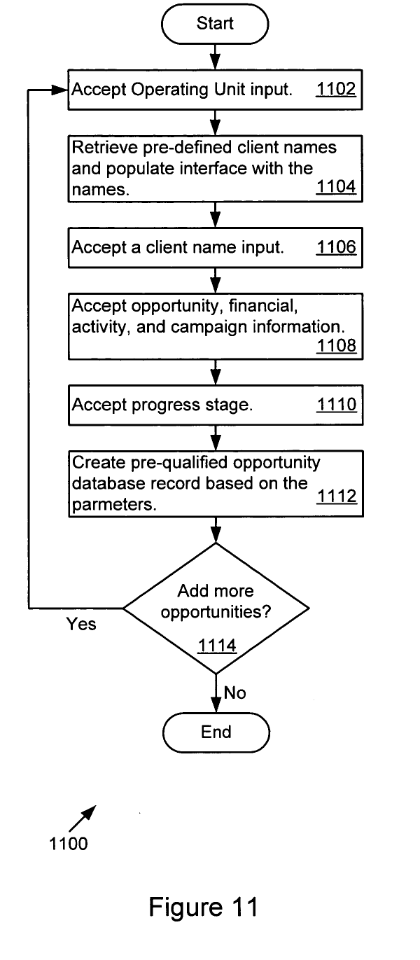

FIG. 11 shows the acts 1100 which the opportunity definition program 116 may take. Initially, the definition program 116 may accept an operating unit input (Act 1102). In response, the definition program 116 may retrieve client names already established for that operating unit and may populate a selector with the client names (Act 1104). The campaign team may select an existing client name, or may enter a new client name (Act 1106).

The definition program 116 may accept any other target opportunity definition information. As examples, the campaign team may enter opportunity information, financial information, activity and/or comments, campaign data, or any other data for the opportunity (Act 1108). Additionally, the definition program 116 may accept or determine a progress stage for the new target opportunity (Act 1110).

Once the definition program 116 captures the characteristics of the new target opportunity, the system 100 creates a new pre-qualified opportunity record 142 in the opportunity database 122 (Act 1112). The campaign team may continue to enter as many additional target opportunities as desired (Act 1114). The system 100 tracks and reports on the target opportunities over their entire lifecycle.

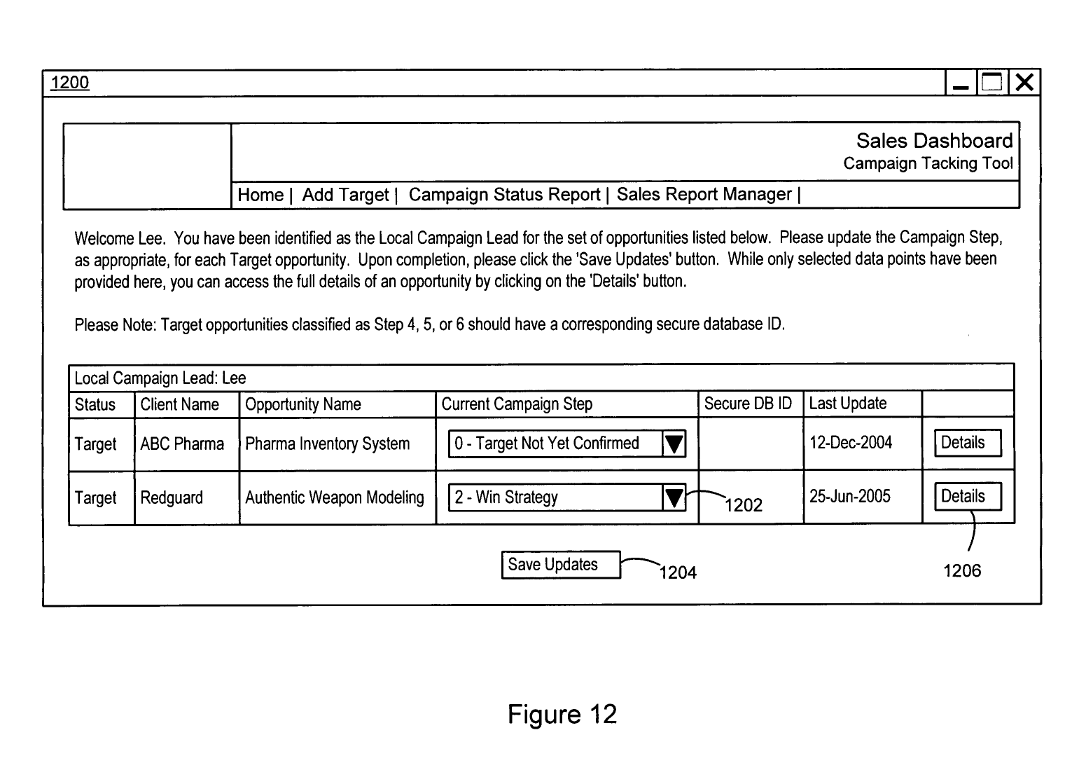

At any desired frequency (e.g., every month), the system 100 may request campaign updates for any of the opportunities. To that end, the system 100 may contact local campaign leads with a reminder to update their assigned opportunities. When the campaign lead logs into the system 100, the system 100 may display an update interface 1200 such as that shown in FIG. 12. The update interface 1200 may include a campaign step selector 1202 for each opportunity and a ‘Save’ button 1204 which prompts the system 100 to save updates. The system 100 responds to the ‘Details’ button 1206 by providing additional detailed information for the corresponding opportunity, such as that described above with respect to FIGS. 4, 5, and 6.

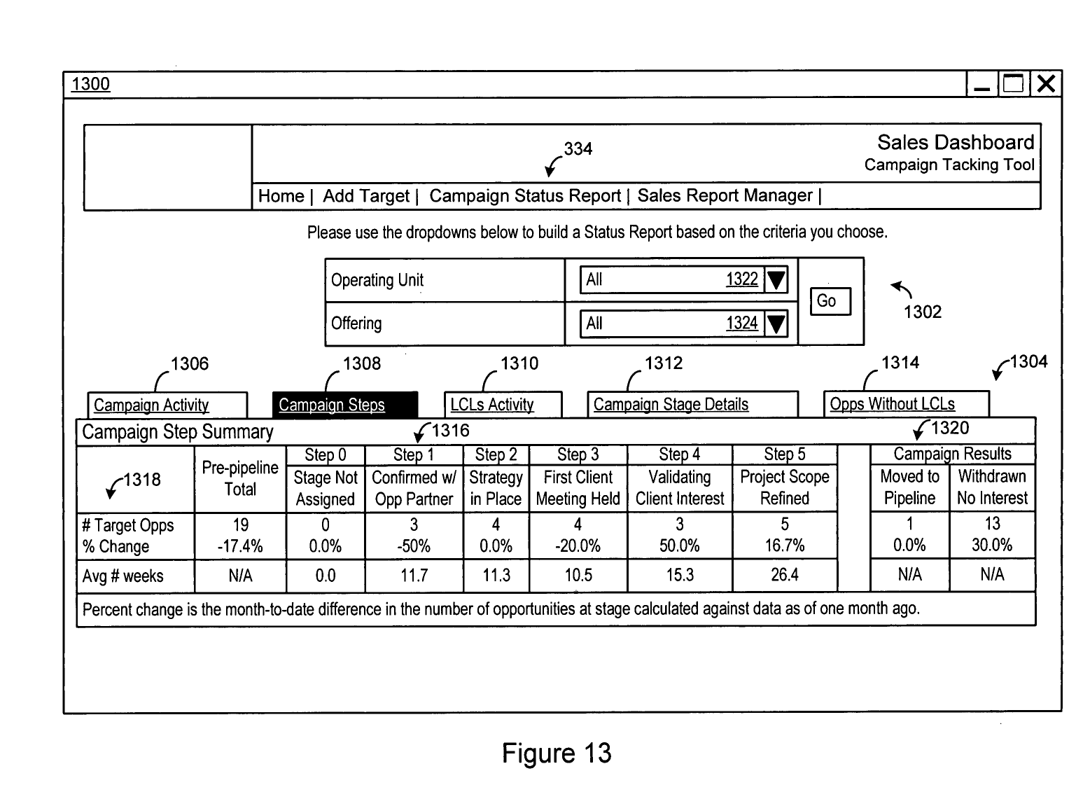

FIG. 13 shows an example of a campaign status report interface 1300. The system 100 may display the interface 1300 in response to activation of the ‘Campaign Status Report’ link 334. In the example shown in FIG. 13, the status report interface 1300 includes a report selector 1302, and a reporting window 1304. The reporting window includes tab selectors: the ‘Campaign Activity’ selector tab 1306, the ‘Campaign Steps’ selector tab 1308, the ‘LCLs Activity’ selector tab 1310, the ‘Campaign Stage Details’ selector tab 1312, and the ‘Opps Without LCLs’ selector tab 1314.

Under the ‘Campaign Activity’ tab, the interface 1300 may display opportunity activity. For example, the interface 1300 may display month-by-month opportunity progress. The interface 1300 may also report the number of opportunities in the pipeline (or at any other progress stage) for the current month versus the prior month. Other reporting time frames (e.g., quarterly or yearly) may be employed.

Under the ‘Campaign Steps’ tab, the interface 1300 may display a progress summary of the opportunities in the database 122. FIG. 13 shows an example of this display. The display includes stage identifiers 1316 for each possible progress stage, a description of the stage, and metrics 1318 associated with each stage. The metrics may include the number of target opportunities at each stage, the percentage change in opportunities at that stage (e.g., compared to one month ago), and the average number of weeks that an opportunity stays at the stage.

The interface 1300 may also provide campaign result metrics 1320. As shown in FIG. 13, the campaign result metrics 1320 may report the number of opportunities moved in the pipeline, the number of opportunities withdrawn (e.g., for lack of interest), or any other campaign result metric.

The ‘LCLs Activity’ tab 1310 may report opportunity information summarized by local campaign lead (LCL). For example, the ‘LCLs Activity’ tab 1310 may report the number of opportunities for which each LCL is responsible. The tab 1310 may also report the number of opportunities each LCL has moved forward.

The ‘Campaign Stage Details’ tab 1312 may report opportunity information summarized by progress stage. The display may include, on an opportunity by opportunity basis, the current progress stage of an opportunity and the number of weeks at the progress stage. In other words, the display may show each opportunity at stage 1, the number of weeks at stage 1; each opportunity at stage 2, the number of weeks at stage 2; and so on.

Under the ‘Opps Without LCLs’ tab 1314, the interface 1300 shows each opportunity which has not been assigned a LCL. The campaign teams may employ this display to identify opportunities which have no LCLs so that LCLs may be assigned.

The report selector 1302 allows the campaign team to select the parameters which filter the opportunities displayed in the interface 1300. In the example shown in FIG. 13, the report selector 1302 includes an operating unit drop down list 1322 and an offering drop down list 1324. Additional, fewer, or different parameter selectors may be provided. In response to campaign team selections from any entry of the parameter selectors, the system 100 updates the interface 1300 with report information for matching opportunities.

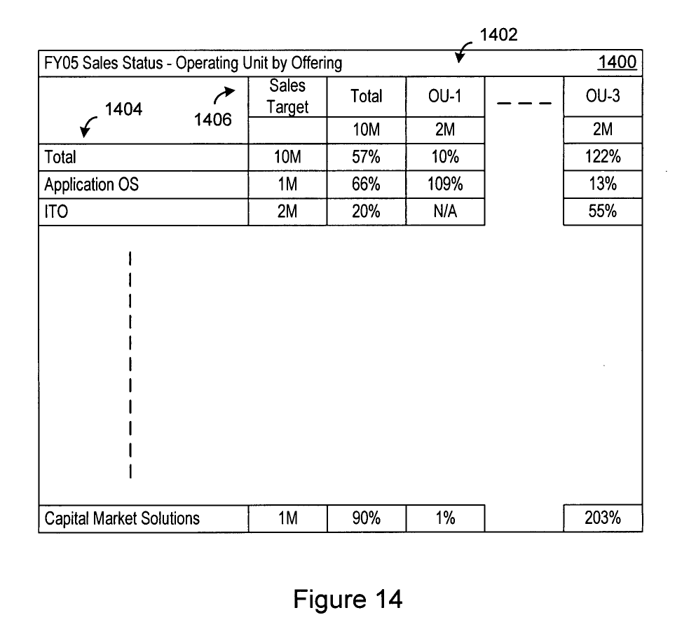

The system 100 distributes sales plan status reports on a periodic (e.g., monthly) basis, and may also provide real-time status updates, as well as access to archives of prior reports. In response to the ‘Sales Report Manager’ link 336, the system 100 may display any prior or current sales plan status report selected by the campaign team. FIG. 14 shows one example of a sales plan status report 1400.

The report 1400 may be arranged by any characteristics of the opportunities. In the example shown in FIG. 14, the status report 1400 is organized by operating unit 1402 and offering 1404. The status report 1400 may display the overall sales targets 1406 and totals for each offering and each operating unit.

At the grid intersections of the opportunity characteristics, the status 1400 may display a sales metric. In FIG. 14, the sales metric is a percentage of sales goal, based on current sales and target sales. For example, the operating unit 1, for application outsourcing, is at 57% of goal. As another example, the operating unit 3, for capital market solutions is at 203% of goal. The sales plan status report may display metrics, graphs, charts, reports, or any other type of sales reporting displays, including drill down links to additional detail for each component of the report.

The opportunity system provides a globally accessible portal into a complete range of potential opportunities. The opportunity system facilitates the full exploration and development of business opportunities through their entire lifecycles. As a result, the opportunity system ensures that opportunities, particularly emerging opportunities, do not languish undeveloped, and are properly tracked and accounted for as part of a global sales strategy.

Furthermore, the opportunity system provides a consistent reporting interface for the opportunities. The opportunity system thereby facilitates the understandability of opportunity progress, financial performance, and opportunity potential. A consistent reporting interface may be employed regardless of where an opportunity exists in its lifecycle.

The opportunity system also provides enhanced database security. The opportunity database allows data assets to be established and to evolve, without requiring access to a secure database of fully developed data assets. Thus, the opportunity system provides a separate development environment in which data assets may mature without requiring access to the more secure database. As a data asset reaches maturity, the opportunity system may then initiate transfer of the matured data asset to an authorized maintainer of the more secure database.

It is therefore intended that the foregoing detailed description be regarded as illustrative rather than limiting, and that it be understood that it is the following claims, including all equivalents, that are intended to define the spirit and scope of this invention.

1. A data processing system comprising:
an opportunity database comprising opportunity records for both qualified and pre-qualified opportunities, the opportunity database further comprising a progress stage field which distinguishes between at least pre-qualified opportunities and qualified opportunities;
a communication interface;
memory comprising:
an import program comprising instructions which:
receive qualified opportunity data through the communication interface from a qualified opportunity repository; and
create the qualified opportunity records in the opportunity database based on the qualified opportunity data; and
an opportunity search program comprising instructions which:
accept opportunity search parameters comprising an opportunity type;
initiate an opportunity search in the opportunity database across both qualified and pre-qualified opportunities based on the opportunity search parameters;
obtain opportunity search results from the opportunity search; and
provide the opportunity search results to an opportunity reporting interface; and
a processor which executes the import program and the opportunity search program.

2. The data processing system of claim 1, where the opportunity search parameters comprise the opportunity type and an operating group.

3. The data processing system of claim 2, where the opportunity search parameters further comprise a market group, industry, or offering, or any combination thereof.

4. The data processing system of claim 2, where the opportunity search parameters further comprise a campaign lead.

5. The data processing system of claim 1, where the memory further comprises:
an export program comprising instructions which:
determine a newly qualified opportunity based on the progress stage field; and
initiate communication of the newly qualified opportunity through the communication interface to the qualified opportunity repository.

6. The data processing system of claim 1, where the progress stage field represents completion of at least one of four opportunity progress stages.

7. The data processing system of claim 6, where the four opportunity progress stages comprise an ‘opportunity confirmation’ stage, a ‘win strategy’ stage, and a ‘first client meeting’ stage, and a ‘validated client interest’ stage.

8. The data processing system of claim 7, where the progress stage field distinguishes between at least six opportunity progress stages which further include an ‘opportunity scope refined’ stage and a ‘pipeline’ stage.

9. The data processing system of claim 1, where the opportunity reporting interface comprises:
a stage selection interface;
an opportunity reporting interface populated with the opportunity search results; and
a supplemental opportunity search interface; and where:
the opportunity search program instructions which accept the opportunity search parameters comprise:
instructions which accept the opportunity search parameters from an initial opportunity search user interface; and
instructions which subsequently accept additional opportunity search parameters from the supplemental opportunity search interface.

10. The data processing system of claim 9, where the opportunity reporting interface further comprises:
a target selector leading to a pre-qualified opportunity interface display comprising client name and opportunity name information for pre-qualified opportunities in the search results; and
a qualified opportunity selector to a qualified opportunity interface display comprising client name and opportunity name information for qualified opportunities in the search results.

11. A method for tracking opportunities, the method comprising:
determining a division of opportunities between a first category and a second category;
subdividing the first category into a first set of progress stages;
subdividing the second category into a second set of progress stages;
establishing an opportunity database comprising opportunity data representing opportunities in both the first category and the second category;
distinguishing between the progress stages, the first category, and the second category using a progress stage field;
determining a set of opportunity search parameters applicable across the first category and the second category;
accepting a selection of the search parameters including at least an opportunity type parameter;
initiating a search of the opportunity database based on the selection;
obtaining opportunity search results from the search; and
populating an opportunity reporting interface with the search results.

12. The method of claim 11, where the first category comprises qualified opportunities and where the second category comprises pre-qualified opportunities.

13. The method of claim 11, further comprising:
importing first category opportunities into the opportunity database from a secure database.

14. The method of claim 13, further comprising:
monitoring the progress stage field; and
identifying an evolved opportunity when a second category opportunity has advanced far enough to qualify as a first category opportunity.

15. The method of claim 14, further comprising:
exporting the evolved opportunity to the secure database.

16. The method of claim 14, where the first set of progress stages comprises at least three progress stages.

17. The method of claim 14, where the second set of progress stages comprises at least three progress stages.

18. A product comprising:
a machine readable medium; and
instructions encoded on the medium which cause a data processing system to perform a method comprising:
establishing a division of opportunities between a first category and a second category;
interacting with an opportunity database comprising opportunity data representing opportunities in both the first category and the second category;
determining a set of opportunity search parameters applicable across the first category and the second category;
accepting a selection of the search parameters;
initiating a search of the opportunity database based on the selection;
obtaining opportunity search results from the search; and
populating an opportunity reporting interface with the search results.

19. The product of claim 18, where the method further comprises:
accepting a progress update for a second category opportunity in the opportunity database; and
updating a progress stage field based on the progress update for the second category opportunity in the opportunity database.

20. The product of claim 19, where the method further comprises:
monitoring the progress stage field; and
identifying an evolved opportunity when a second category opportunity has advanced far enough to qualify as a first category opportunity.

21. The product of claim 20, further comprising:
exporting the evolved opportunity to the secure database.

22. The product of claim 18, where interacting with an opportunity database comprises:
establishing a qualified opportunity record; and
establishing a pre-qualified opportunity record.

23. The product of claim 18, where interacting with an opportunity database comprises:
product an activity log record; and
establishing an evolved opportunity record.

24. The product of claim 18, where interacting with an opportunity database comprises:
establishing a campaign information record comprising a progress stage field.

25. A method of searching a database, comprising:
storing first category data records in a first database;
storing second category data records in a second database;
creating duplicate, read-only copies of the second category data records in the first database;
performing a search of the first category data records and the duplicate copies of the second category data records in the first database.

26. The method of claim 25, wherein creating duplicate copies comprises importing the second category data records into the first database from a secure remotely located second database.

27. The method of claim 26, wherein the first database is stored on a first computer system and wherein importing comprises initiating execution of an import program.

28. The method of claim 25, further comprising exporting an evolved data record to the second database as a new second category data record.

29. The method of claim 28 further comprising creating an evolved opportunity record in the first database for the exported evolved data record.

30. A database system comprising:
a computer system comprising a first database storing first category data records, a search program and an import program; and
a second database storing second category data records, remote from the computer system;
wherein the import program is programmed to import duplicate, read-only copies of the second category data records from the second database into the first database and the search program is programmed to perform a search across both the first category data records and the duplicate copies of the second category data records in the first database.

31. The database system of claim 30, wherein the computer system further comprises an export program operable to export an evolved data record to the second database as a new second category data record.

32. The database system of claim 31 wherein the first database further comprises an evolved opportunity record which tracks the exported evolved data record.

33. The database system of claim 30 wherein the first category data records comprise multiple progress stage fields and progress completion date fields.
